(19) United States
(12) Patent Application Publication
(10) Pub. No.: US 2015/0086287 A1
(43) Pub. Date: Mar. 26, 2015

(54) PIPE THREADING SYSTEM FOR A HANDHELD DRILL

(71) Applicant: Impact Pipe Power, Manchester (GB)

(72) Inventors: Gregory Connolly, Moston (GB); Matthew Christopher Jon Keigher, Bolton (GB)

(73) Assignee: Impact Pipe Power

(21) Appl. No.: 14/494,531

(22) Filed: Sep. 23, 2014

Related U.S. Application Data
(60) Provisional application No. 61/881,438, filed on Sep. 23, 2013.

(51) Int. Cl. B23B 27/06; B23B 51/12

(52) U.S. Cl. CPC B23B 27/065; B23B 51/12; B23B 2215/72; B23B 2215/68
USPC 408/204

(57) ABSTRACT

The present disclosure provides a pipe threading system including an adapter and an attachment for a handheld electric drill that applies a threading to the outer surface of a pipe. The system includes at least one dies shaped to cut a thread of the pipe. The attachment includes a central open bore to allow the threading of pipe sections beyond the length of the die's cutting surface.

### CROSS-REFERENCE TO RELATED APPLICATIONS

This application incorporates by reference and claims priority to U.S. Provisional Application 61/881,438 filed on Sep. 23, 2013.

### BACKGROUND OF THE INVENTION

The present subject matter discloses an attachment for a handheld electric drill that applies a threading to the outer diameter of a round pipe. The attachment incorporates dies shaped to cut a thread, and connects to a handheld drill via an adapter.

Pipes are commonly used to transport gasses, liquids and viscous or granulated solids. They see widespread use in the plumbing, construction and petroleum industries, among others. Pipes are often connected to a fitting or device through an attachment mechanism. Spiral threading on a pipe's outer diameter provides one method of attachment by interlocking with corresponding threads on the inner diameter of a fitting. Applying a thread to a pipe can increase its value and capabilities.

However, previous pipe-threading methods were expensive and cumbersome. They often required completely unique tools and lacked the ability to work in remote or hard-to-access places. Other attempts required manual power while alternatives were large and non-portable. Accordingly, there is a need for a pipe-threading device that is compact, inexpensive and powered by a handheld electric drill, as described herein.

### BRIEF SUMMARY OF THE INVENTION

To meet the needs described above and others, the present disclosure provides a convenient, portable and cost-effective system for threading the outer diameter of a pipe. Although the present disclosure describes threading pipes, it is understood that the present disclosure may be used to thread any cylindrical body, for example, the present disclosure may be applied to electrical conduits, ducts, etc.

This invention may include an adapter and an attachment system. The adapter may include a spindle to fit into a standard drill chuck, and may secure to the attachment using a number of fasteners, such as set screws. Alternatively, or in addition to, the adaptor and/or attachment system may be incorporated into a complete removable drill head. The cross section of the spindle may be any suitable shape including a circle, triangle, square, rectangle, pentagon, hexagon, among others. The attachment includes an attachment head containing slits for cutting dies. Dies incorporate cutting surfaces and create a thread pattern on a pipe when powered by a connected handheld electric drill. A die-retaining faceplate fastens to the attachment head and secures the dies within the head's die slits. The attachment head incorporates a central bore opening to cut pipe lengths longer than the die's cutting surface. Additionally, the attachment head includes openings for cooling and for the release of metal shavings.

The invention may be used by placing the spindle of the adapter into the chuck of a handheld electric drill and securing it with a chuck key, in the same manner as with other drill attachments. The user then selects the appropriately sized attachment head and secures it into the adapter. Upon attachment, the drill is able to power the attachment via the adapter. The attachment is placed at the end of an unthreaded pipe and the cutting surfaces of the dies come into contact with the pipe. Upon operating the drill, the dies create a threading on the outer diameter of the pipe. Once the cutting surfaces engage the pipe, the attachment will secure to the pipe and be driven along the pipe's outer surface by the electric drill. A central bore through the attachment head allows the dies to continue threading along the pipe beyond the length of the cutting surface, as the threaded pipe section passes into the bore. The drill's rotational direction can be reversed for chasing the thread or for removing the attachment from the threaded pipe.

The present disclosure provides a.

Benefits of this system result from the small size of the invention relative to previous pipe-threading devices. The small size allows a user to work in more locations and allows greater flexibility when working on existing pipes in situ. It also eases handling and portability.

An additional advantage of the system is the ability to quickly thread differently sized pipes by switching between different attachment sizes.

A further benefit of the invention is the ability to quickly create different thread patterns and depths by switching between dies with different cutting surface arrangements.

Other advantages of the system provided herein are a result of using an electric motor, rather than manual effort, as the primary power source. Relative to a manually powered threading system, an electric solution will deliver power more consistently and may decrease vibrations. The use of an electric motor will also reduce an operator's physical fatigue. Depending on the drill's motor, the electric motor may be able to provide more torque than a manually powered system. An electric motor may also be more compact than a hand crank or other manual power mechanism. Additionally, an electric motor may create a thread faster than a manual system.

Significant advantages stem from using a conventional handheld electric drill as a power source. Such drills are commonplace in mechanical working environments. The user will not need to buy a complete dedicated threading system or an additional external power source, decreasing total system costs. The use of an external, and widely-used, power supply allows the attachment and adapter to take up less space and weigh less than if a dedicated power supply was incorporated.

Another advantage of the system is the ability to quickly thread pipes made from different materials by switching between dies with cutting surfaces suited to cut various pipe materials. Additionally, dies themselves could be made from different materials suited to cut different pipes.

Further benefits derive from the attachment's low weight when compared to previous threading devices. Lower weight eases handling and decreases the user's physical fatigue. It also facilitates greater portability.

Additional objects, advantages and novel features of the examples will be set forth in part in the description which follows, and in part will become apparent to those skilled in the art upon examination of the following description and the accompanying drawings or may be learned by production or operation of the examples. The objects and advantages of the concepts may be realized and attained by means of the methodologies, instrumentalities and combinations particularly pointed out in the appended claims.

### BRIEF DESCRIPTION OF THE DRAWINGS

The drawing figures depict one or more implementations in accord with the present concepts, by way of example only, not by way of limitations. In the figures, like reference numerals refer to the same or similar elements.

FIG. 1A is a perspective view of an example of the system disclosed herein.

FIG. 1B is an exploded view of an embodiment of the system disclosed herein and illustrated in FIG. 1A.

FIG. 2A is a top perspective view of an embodiment of an adaptor as disclosed herein.

FIG. 2B is a perspective view of an example of a spindle connected to an adaptor.

FIG. 3 is a perspective view of an example of an attachment head including openings.

FIG. 4 is a top view of another example of a die-retaining faceplate including a view of the central bore.

FIG. 5 is a perspective view of an embodiment of dies and their cutting surfaces.

FIGS. 6A-6B are side views of an embodiment of an adaptor and the attachment system disclosed herein including a guide to correctly feed the pipe into the device.

### DETAILED DESCRIPTION OF THE INVENTION

The present invention is directed to a pipe threading system 10 including an adapter 12 and an attachment 14 for a handheld electric drill that applies a threading to the outer diameter of a pipe. The system 10 includes at least one dies 16 shaped to cut a thread on an outer surface of a pipe. The attachment 14 includes a central open bore 20 to allow the insertion of a pipe to enable threading the pipe sections beyond the length of the die's cutting surface.

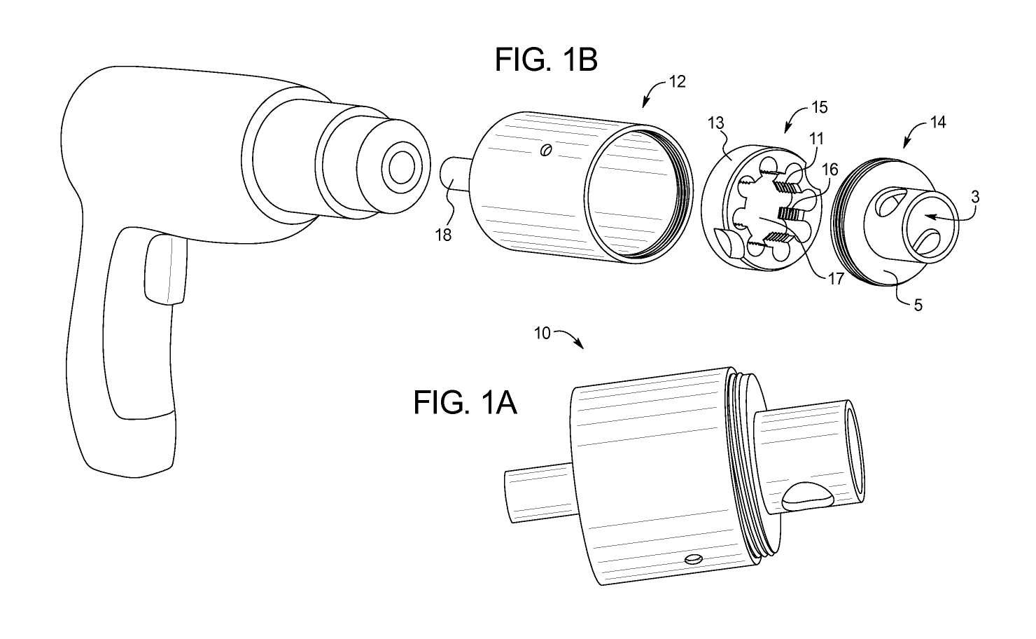

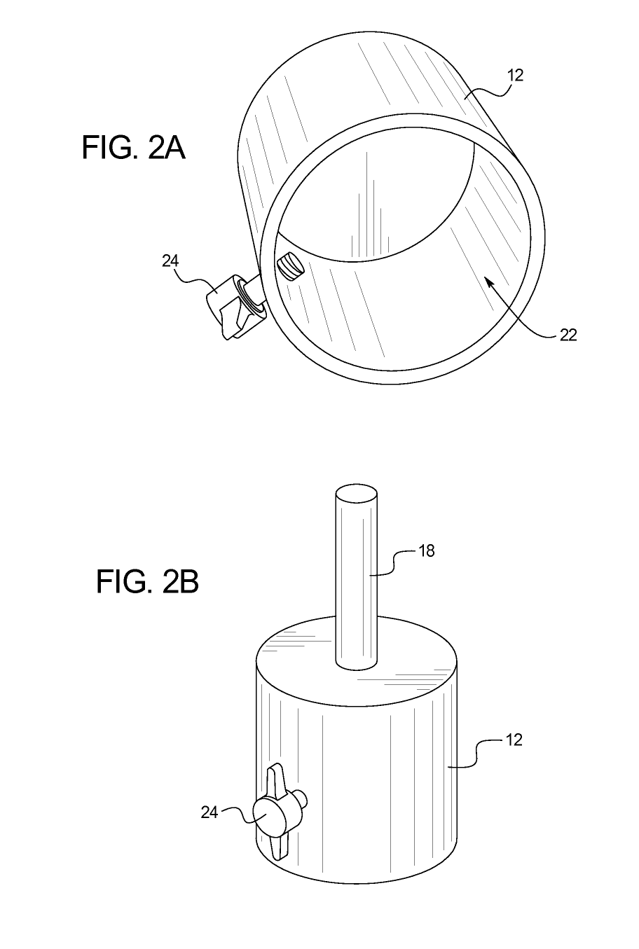

The adapter 12, as shown in FIGS. 1A-1B, is used to connect the attachment 14 to a handheld electric drill. The adaptor 12 may be composed of a ferrous alloy, another metallic alloy or a polymer. This adapter 12 may include a cylindrical chamber 22 for receiving a cylindrical insert 15 and/or the attachment 14. The adapter 12 may also include a spindle 18 that secures into the chuck of the handheld electric drill, as shown in FIG. 2. The spindle 18 may extend from a closed end of the cylindrical chamber 22 of the adaptor 12. The spindle 18 may work with right-angle and standard drills. An inner surface of the chamber 22 may include a smooth inner surface or include lengthwise grooves that interlock with optional corresponding grooves on an outer surface of the attachment 14 to ensure the axial rotation of the adapter 12 imparts equal axial rotation of the attachment 14.

As shown in the embodiment depicted in FIG. 1, the die 16 may be in the form of a cylindrical insert 15, wherein the cylindrical insert 15 may be inserted within the chamber 22 of the adaptor 12. The cylindrical insert 15 may exist in different sizes to thread pipes with a range of outer diameters. The cylindrical insert 15 may include an inner surface 11 defining a central insert opening 17, wherein the inner surface 11 includes at least one die 16. For example, the inner surface 11 may include a plurality of die 16 surfaces. The cylindrical insert 15 may include an outer surface 13 that contacts the inner surface of the cylindrical chamber 22 of the adapter 12. The cylindrical insert may be removeably inserted into the cylindrical chamber 22 of the adaptor 12. Alternatively, the cylindrical insert 15 may be attached to the attachment 14, which is removeably attached to the adaptor 12.

The attachment 14 may attach to the adaptor 12 to enclose cylindrical insert 15 within the system 10. The attachment 14 may hold the cylindrical insert 15 in place. Alternatively, or in addition to, the adaptor 12 may include a temporary locking mechanism to hold the cylindrical insert 15 in place. For example, the chamber 22 may include grooves to receive corresponding grooves in an outer surface of the cylindrical insert 15. The chamber 22 may include various other mechanisms to fasten the cylindrical insert 15 to the adaptor 12, including, but not limited to, threading, screws, pressure, or any other suitable fastening mechanism.

As shown in FIG. 1, the attachment 14 may include a cylindrical disk 5 and a cylindrical guide 36 extending from a central attachment opening 3 within the cylindrical disk 5. Of course, the cylindrical disk 5 may be any suitable shape, including hexagonal. The central attachment opening 3 is aligned with the central insert opening 17 to receive a pipe to be threaded. The outer perimeter of the cylindrical disk 5 may include threading to mate with a threaded portion of the inner surface of the chamber 22. Alternatively, or in addition to, notches may be included on a surface of the cylindrical disk 5 that prevent the cylindrical disk 5 from spinning.

In one embodiment, the adapter 12 may include one or more fasteners 24, such as set screws to secure the attachment 14 to the adapter 12. For example, a screw may attach the cylindrical disk 5 of the attachment 14 to the chamber 22 of the adaptor 12. Alternative embodiments may use clamps or threaded sections to secure the attachment 14 to the adapter 12, as will be recognized by one of ordinary skill in the art from the examples provided.

In another embodiment, the system 10 may include a spindle 18 rigidly connected to the attachment 14, foregoing the need for an adapter 12. In an example, the attachment 14 and adaptor 12 may be one piece, instead of two separate pieces. Further the die 16 and/or cylindrical insert 15 may not be a separate piece, but part of the adaptor 12 or attachment 14.

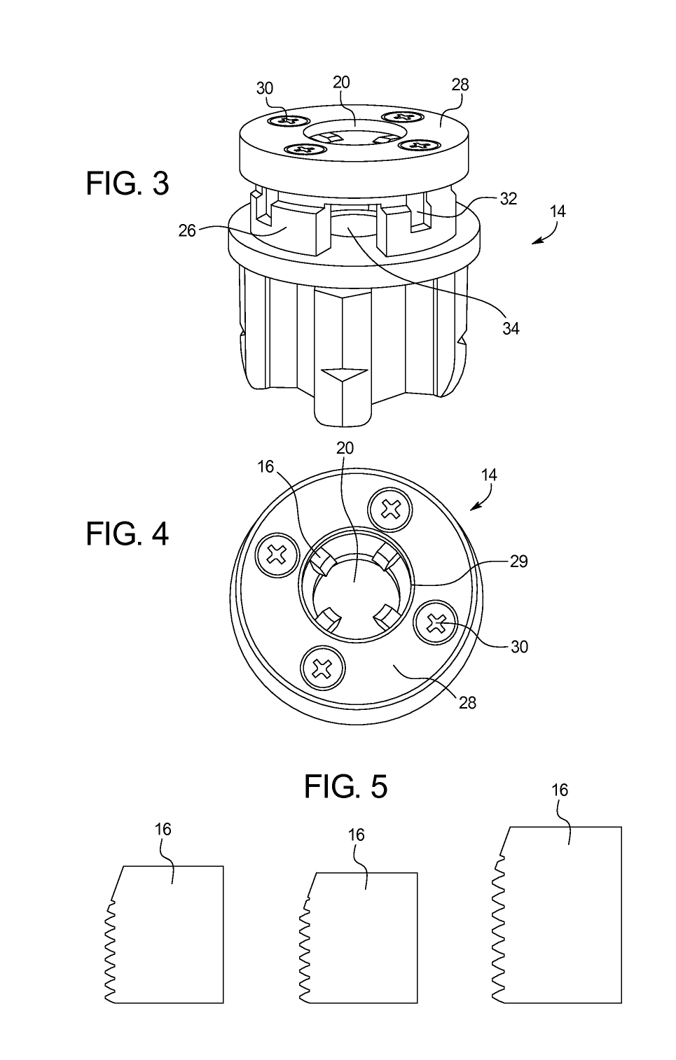

The attachment 14 may include an attachment head 26 and a die-retaining faceplate 28 to receive at least one die 16, as shown in FIGS. 3-4. The attachment head 26 may exist in different sizes to thread pipes with a range of outer diameters. The attachment head 26 may be composed of a ferrous alloy, another metallic alloy or a polymer. The attachment head 26 may include a number of die slits 32 used to accept dies 16. In an embodiment, the attachment head includes four die slits 32. Alternative embodiments may include fewer or more die slits 32. The attachment head 26 may also incorporate lengthwise grooves in an outer surface of the attachment 14 or attachment head 26 that interlock with corresponding grooves in an inner surface of the adapter 12. In addition, a cylindrical spacer may be inserted into the attachment head 26 to set the length of the threading on the inserted pipe.

In an embodiment, the attachment 14 contains threaded screw holes used to fasten the die-retaining faceplate 28 to the attachment 14 with a fastener 30, such as screws. Other embodiments may include the use of clamps, magnets, or other fasteners to secure the die-retaining faceplate 28 to the attachment 14.

As shown in FIG. 3, he attachment head 26 may incorporate openings 34 between the die slits 32. These allow metal shavings from previous cuts to exit the attachment head 26. The openings 34 also allow thermal cooling of the pipe and dies through natural convection by providing channels for air to enter and escape. The channels also allow the concurrent use of cutting fluid, or other liquids, to lubricate and cool the attachment 14. They also reduce the mass of the attachment head 26. Additionally, a user may be able to view the pipe through the openings 34 and gauge the length of pipe that has been threaded.

As shown in FIG. 4, the die-retaining faceplate 28 secures one or more dies 16 within the attachment head 26. The dies 16 are secured within the die slits 32 of the attachment head 26. In such embodiment, the dies 16 may be linear, as shown in FIG. 5, wherein the linear dies 16 are configured to fit or slide into the slits 32 along the inner surface of the attachment head 26.

The die-retaining faceplate 28 may be removable to permit the replacement of dies 16, and may be secured to the attachment 14 by several fasteners 30, which are screws in the shown embodiment. The die-retaining faceplate 28 may contain holes, corresponding to the threaded holes in the attachment head 26, which allow the die-retaining faceplate 28 to be fastened to the attachment head 26 with fasteners 30. The die-retaining faceplate 28 may be fabricated from a metal alloy or polymer. The faceplate 28 may include a faceplate central opening 29 aligned with the central open bore 20 to receive a pipe for threading.

The attachment head 26 defines an interior attachment chamber that includes a central open bore 20 that accepts sections of pipe that have already been threaded. This bore 20 allows the threading of pipe sections that extend deeper than the length of the die cutting surfaces.

The attachment head 26 may include a number of slits 32 for accepting each die 16. These slits 16 may be accessed by removing the die-retaining faceplate 28. Dies 16 are secured in their slits by fastening the faceplate 28. These slits 16 may exhibit radial symmetry around the attachment head 26. The dies 16 also may be spaced such that cutting surfaces from successive dies follow the same thread pattern as previous cuts, deepening the existing thread. The use of multiple dies 16 eases the wear and load on the dies 16.

Dies 16 may be composed of hardened metal alloys, similar to those used in other bits and tools. Each die 16 includes a series of cutting surfaces, as shown in FIGS. 1 and 5. When the drill is operated with the attachment 14, the cutting surfaces of the die 16 contact the outer surface of the pipe. The cutting surfaces may be tapered such that each progressively cuts deeper into the pipe. Such arrangement forms the thread pattern gradually, with successive cuts removing small amounts of pipe material. This reduces stress on the dies 16, the attachment 14, and the electric drill. The forward section of the cutting surface, that first comes into contact with the pipe, may incorporate a bevel or chamber to center and stabilize the attachment 14 to the pipe when beginning to cut a thread. As the threading progresses to the deeper cutting surfaces, the die 16 stabilizes the attachment 14 and allow it to be driven along the pipe by the electric drill. Die 16 may also be used to chase the thread when the drill is operated in the opposite direction. Die 16 can incorporate different cutting surfaces to create different thread patterns or cutting depths. They may also be composed of different materials to cut various types of pipe. Die 16 may be replaced due to wear or cutting properties.

The cutting surfaces on the dies 16 may be angled such that when operating the drill and attachment, the cutting surfaces are driven inward from the end of the pipe as it is threaded. The dies 16 may also be spaced so that cutting surfaces on successive dies 16 follow the same thread cut by a previous die, progressively deepening the existing cut. This cutting sequence creates a spiral threading starting from the end of the pipe and extending inward.

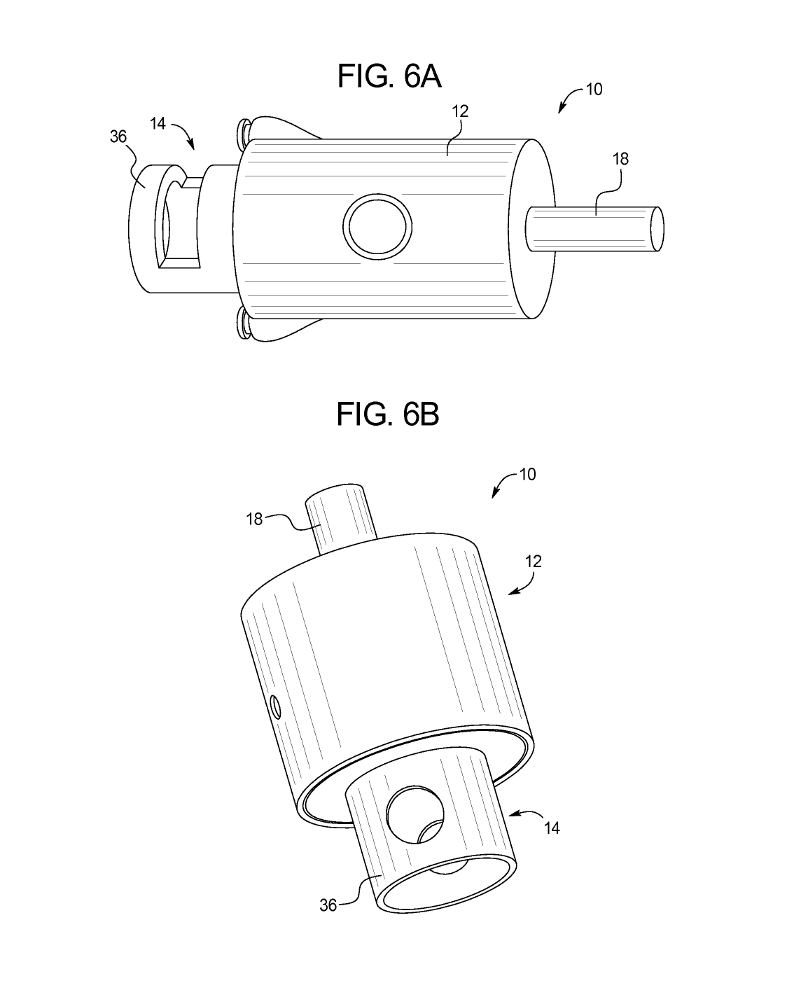

As shown in FIGS. 6A-6B, the system 10 may include a cylindrical guide 36 to correctly feed the pipe straight into the device. For example, the cylindrical guide 36 may extend from faceplate central opening 29 of the attachment, wherein the cylindrical guide 36 is configured to receive a pipe. The faceplate central opening 29 is aligned with the central open bore 20. In the figure, the guide 36 is shown on the front of a second adapter. In an embodiment, the guide 36 may be permanently affixed to the attachment head 26. In other embodiments, the guide 36 may be removable. The attachment head 26 may be configured to interoperate with multiple guides 36 of varying sizes to accommodate pipes of multiple sizes.

It should be noted that various changes and modifications to the embodiments described herein will be apparent to those skilled in the art. Such changes and modifications may be made without departing from the spirit and scope of the present invention and without diminishing its attendant advantages. For example, various embodiments of the method and portable electronic device may be provided based on various combinations of the features and functions from the subject matter provided herein.

We claim:

1. A pipe threading system comprising:
an adaptor including a cylindrical chamber and a spindle, wherein the spindle is configured to engage with a handheld electric drill;
a cylindrical insert including an outer surface and an inner surface, wherein the inner surface defines a central insert opening, wherein the inner surface includes at least one die, wherein the cylindrical insert is removeably positioned within the cylindrical chamber; and
an attachment removeably connected to the adaptor, wherein the attachment includes a cylindrical disk and a cylindrical guide extending from a central attachment opening within the cylindrical disk,
wherein the central insert opening is aligned with the central attachment opening to receive a pipe for threading.

2. The system of claim 1 wherein the cylindrical disk includes a disk outer surface defining a perimeter of the cylindrical disk, wherein at least a portion of the disk outer surface includes a disk threading, wherein the disk threading removeably engages with a chamber threading along a portion of an inner surface of the cylindrical chamber of the adaptor.

3. The system of claim 1 further comprising a screw, wherein the screw removably attaches the cylindrical disk of the attachment to the cylindrical chamber of the adaptor.

4. The system of claim 1 wherein the cylindrical guide includes at least one surface opening within a sidewall of the cylindrical guide to allow air to flow through the attachment.

5. The system of claim 1 wherein a plurality of cutting surfaces of the die define the inner surface of the cylindrical insert.

6. The system of claim 1 wherein the spindle is attached to an outer surface of a closed end of the chamber, wherein an open end of the chamber is configured to receive the cylindrical disk of the attachment.

7. A pipe threading system comprising:
an adaptor including a cylindrical chamber and a spindle, wherein the spindle is attached to an outer surface of a closed end of the cylindrical chamber, wherein the spindle is designed to engage with a handheld electric drill; and
an attachment removably connected to the adaptor, wherein the attachment includes:
a cylindrical attachment body including an interior attachment chamber, wherein the attachment chamber includes a central open bore configured to receive a pipe,
at least one die within the attachment chamber, wherein a cutting surface of the die defines an inner surface of the central open bore, and
a faceplate removably attached to an end of the cylindrical attachment body, wherein the faceplate secures the at least one die within the attachment chamber, wherein the faceplate includes a faceplate central opening, wherein the faceplate central opening aligns with the central open bore to receive a pipe for threading.

8. The system of claim 7 wherein the attachment chamber includes at least one die slit configured to receive a die.

9. The system of claim 7 wherein the cylindrical attachment body includes at least one opening within a sidewall of the cylindrical attachment body to allow air to flow through the attachment.

10. The system of claim 7 wherein a plurality of cutting surfaces of a plurality of dies within the attachment chamber define the central open bore of the attachment chamber.

11. The system of claim 7 wherein the cylindrical chamber receives at least a portion of the attachment.

12. The system of claim 7 further comprising a cylindrical guide extending from faceplate central opening of the attachment, wherein the cylindrical guide is configured to receive a pipe.

13. The system of claim 7 wherein a portion of an outer surface of the attachment includes an attachment threading, wherein the attachment threading removeably engages with an adaptor threading along a portion of an inner surface of the cylindrical chamber of the adaptor.

14. The system of claim 7 further comprising a screw, wherein the screw removeably attaches the adaptor to the attachment.
